(19) United States
(12) Patent Application Publication
(10) Pub. No.: US 2011/0075056 A1
(43) Pub. Date: Mar. 31, 2011

(54) Projection Display Apparatus

(75) Inventors: Kouichi TSUTSUMI, Osaka (JP); Kazunori KOTANI, Nara-city (JP)

(73) Assignee: SANYO ELECTRIC CO., LTD., Osaka (JP)

(21) Appl. No.: 12/893,820

(22) Filed: Sep. 29, 2010

(30) Foreign Application Priority Data
Sep. 29, 2009 (JP) 2009-225597

(51) Int. Cl. H04N 9/31

(52) U.S. Cl. 348/744; 348/E09.025

(57) ABSTRACT

A projection display device includes a first communication processing section for performing communications over a network; an interface that is connected to a communication device having a second communication processing section with more advanced processing capability than that of the first communication processing section; and a selecting section that selects the first communication processing section or the second communication processing section disposed in the communication device, for use in communications with the network.

This application claims priority under 35 U.S.C. Section 119 of Japanese Patent Application No. 2009-225597 filed Sep. 29, 2009, entitled “PROJECTION DISPLAY DEVICE”. The disclosure of the above applications is incorporated herein by reference.

### BACKGROUND OF THE INVENTION

1. Field of the Invention

The present invention relates to projection display devices that modulate light from alight source and project the same onto a projection plane.

2. Disclosure of Related Art

Conventionally, projection display devices connectable to networks (hereinafter, referred to as “projectors”) have been developed. For example, the projectors can be configured to receive image signals from external devices (such as personal computers and the like) via networks and project images in accordance with the image signals. In this case, the projectors need to include a circuit section for extracting digital data corresponding to image signals from received communication signals and processing the same. Such a circuit section is comparatively expensive and therefore may lead to cost increase of the entire projector.

In another possible configuration of projectors, the projectors are connected to networks for the purpose of remote control of the projectors. In this case, the projectors only need to be capable of receiving control signals from the networks and transmitting signals indicative of projector status and the like to the network. This configuration does not require a circuit section for extracting digital data corresponding to image signals from communication signals and processing the same, whereby it is possible to suppress cost increase of the entire projector as compared to the foregoing mode.

Which of the foregoing two configurations is desired depends on a user. Accordingly, it is desired that projectors are adaptively configured to respond smoothly to the user's needs while suppressing cost increase as much as possible.

### SUMMARY OF THE INVENTION

A principal aspect of the present invention relates to a projection display device that modulates light from a light source and projects the same onto a projection plane. A projection display device in this aspect includes a first communication processing section for performing communications over a network; an interface that is connected to a communication device having a second communication processing section with more advanced processing capability than that of the first communication processing section; and a selecting section that selects the first communication processing section or the second communication processing section disposed in the communication device, for use in communications with the network.

According to the projection display device in the principal aspect of the present invention, a user can select as appropriate between a communication mode with the first communication processing section and a communication mode with the second communication processing section. In addition, the second communication processing section is disposed in the communication device which is an external communication device, not in the projection display device, thereby allowing the projection display device to circumvent cost increase due to the second communication processing section.

### BRIEF DESCRIPTION OF THE DRAWINGS

The foregoing and other objects and novel features of the present invention will be more fully understood from the following description of the preferred embodiments when reference is made to the accompanying drawings.

FIG. 1 is a diagram showing a configuration of a projector in an embodiment of the present invention;

FIG. 2 is a diagram showing a configuration of an optical engine in the embodiment;

FIG. 3 is a circuit block diagram showing a configuration of main components of the projector in the embodiment which relate to communications with an external device over a LAN;

FIG. 4 is a circuit block diagram showing a configuration of a functionality expansion unit in the embodiment;

FIG. 5 is a flowchart of a power supply controlling process on a LAN signal processing circuit section and the functionality expansion unit in the embodiment;

FIGS. 6A and 6B are diagrams for describing a communication function setting process in modification example 1;

FIGS. 7A and 7B are diagrams showing examples of a communication function setting window in modification example 1;

FIG. 8 is a flowchart of a power supply control process on the LAN signal processing circuit section and the functionality expansion unit in modification example 1;

FIG. 9 is a flowchart of a communication function setting process in modification example 2;

FIG. 10 is a flowchart of a power supply control process on the LAN signal processing circuit section and the functionality expansion unit in modification example 2;

FIG. 11 is a flowchart of a communication function setting process in modification example 3; and

FIG. 12 is a flowchart of a power supply control process on the LAN signal processing circuit section and the functionality expansion unit in modification example 4.

However, the drawings are only for purpose of description, and do not limit the scope of the present invention.

### DESCRIPTION OF PREFERRED EMBODIMENTS

A preferred embodiment of the present invention will be described below with reference to the drawings.

In this embodiment, a functionality expansion unit 50 is equivalent to a “communication device” recited in the claims; a LAN connector 401 is equivalent to a “first communication processing section” recited in the claims; a LAN signal processing circuit section 402 is equivalent to the “first communication processing section” recited in the claims; a linkage connector 403 is equivalent to an “interface” recited in the claims; a control section 407 is equivalent to a “selecting section”, a “setting section” and an “accepting section” recited in the claims; a power source section 408 is equivalent to a “power supply section” recited in the claims; an input section 409 is equivalent to the “accepting section” and the “setting section” recited in the claims; a LAN connector 501 is equivalent to a “second communication processing section” recited in the claims; a LAN signal processing circuit 502 is equivalent to the “second communication processing section” recited in the claims; and a digital communication signal processing circuit section 503 is equivalent to the “second communication processing section” recited in the claims. However, the foregoing correspondences between the claims and this embodiment are listed merely as examples, and the claims are not limited by this embodiment.

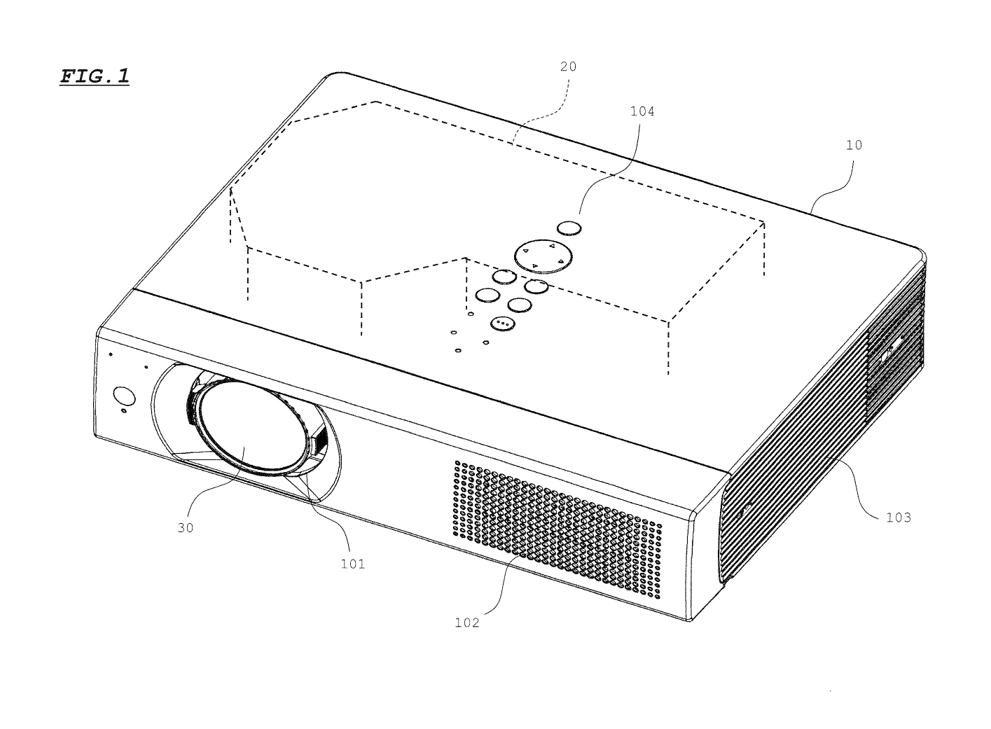

FIG. 1 is a perspective external view of a configuration of a projector. Referring to FIG. 1, the projector includes a cabinet 10 in the shape of a horizontally long, approximate rectangular parallelepiped. The cabinet 10 has a projection window 101 on a left side of a front surface thereof, and exhaust openings 102 and 103 for discharging air from an interior of the cabinet 10 on a right side of the front surface and a right surface thereof. In addition, the cabinet 10 has on a top surface thereof an operating section 104 with a plurality of operation buttons.

The cabinet 10 has therewithin an optical engine 20 and a projection lens 30. The optical engine 20 generates image light modulated by an image signal. The projection lens 30 is attached to the optical engine 20, and a front end of the projection lens 30 is exposed forward at the projection window 101. The projection lens 30 enlarges and projects the image light generated by the optical engine 20 onto a screen plane arranged in front of the projector.

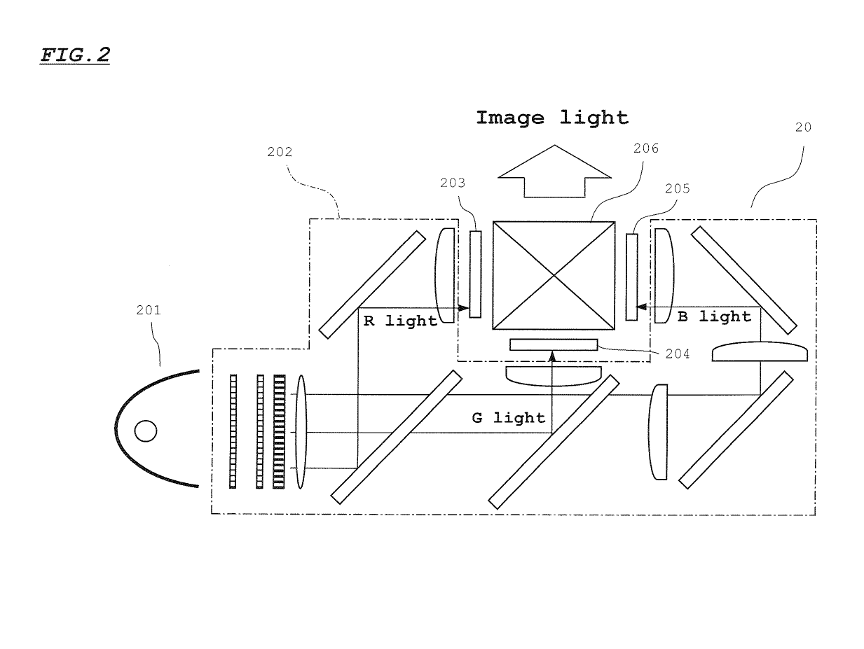

FIG. 2 is a diagram showing a configuration of the optical engine 20.

As shown in FIG. 2, the optical engine 20 includes a light source 201, a light-guiding optical system 202, three transmissive liquid crystal panels 203, 204, and 205, and a dichroic prism 206. In addition, polarizers (not shown) are disposed at incident sides and output sides of the liquid crystal panels 203, 204, and 205.

The light-guiding optical system 202 separates white light emitted from the light source 201 into a red-waveband light (hereinafter, referred to as “R light”), a green-waveband light (hereinafter, referred to as “G light”), and a blue-waveband light (hereinafter, referred to as “B light”), and then radiates the separated lights to the liquid crystal panels 203, 204, and 205. The liquid crystal panels 203, 204, and 205 modulate the R, G, and B lights, and then the dichroic prism 206 combines the modulated lights and emits the same as image light.

As imagers constituting the optical engine 20, there may be used reflective liquid crystal panels or MEMS devices, instead of the transmissive liquid crystal panels 203, 204, and 205. In addition, the optical engine 20 may be not a three-plate optical system with three imagers as described above but a single-plate optical system using one imager and a color wheel, for example.

The projector of this embodiment is capable of communication with an external device such as a personal computer or the like over a local area network (LAN), and is equipped with arrangements for that purpose.

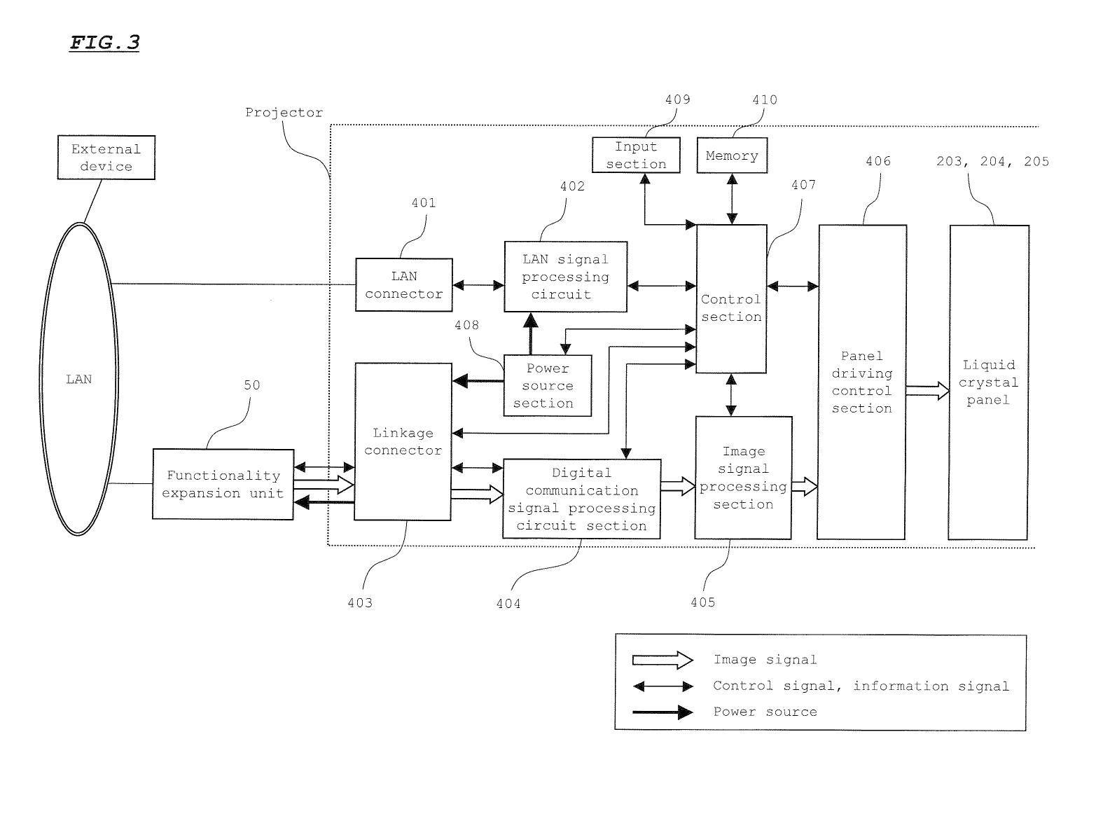

FIG. 3 is a circuit block diagram showing a configuration of main components of the projector which relate to communications with an external device over the LAN.

The projector includes a LAN connector 401, a LAN signal processing circuit section 402, a linkage connector 403, a digital communication signal processing circuit section 404, an image signal processing section 405, a panel driving control section 406, a control section 407, a power source section 408, an input section 409, and a memory 410.

If the LAN signal processing circuit section 402 is to be used, the LAN connector 401 is connected with a LAN cable for LAN communications.

A communication signal from the LAN is input into the LAN signal processing circuit section 402 via the LAN connector 401. This communication signal from the LAN contains a control signal from the external device for remote control of the projector. The LAN signal processing circuit section 402 subjects the communication signal from the LAN to a decoding process and the like for conversion into a digital communication signal capable of being processed by the projector. The LAN signal processing circuit section 402 then outputs the converted signal to the control section 407.

The linkage connector 403 is connected to a functionality expansion unit 50. The functionality expansion unit 50 is configured as a device separated from the projector.

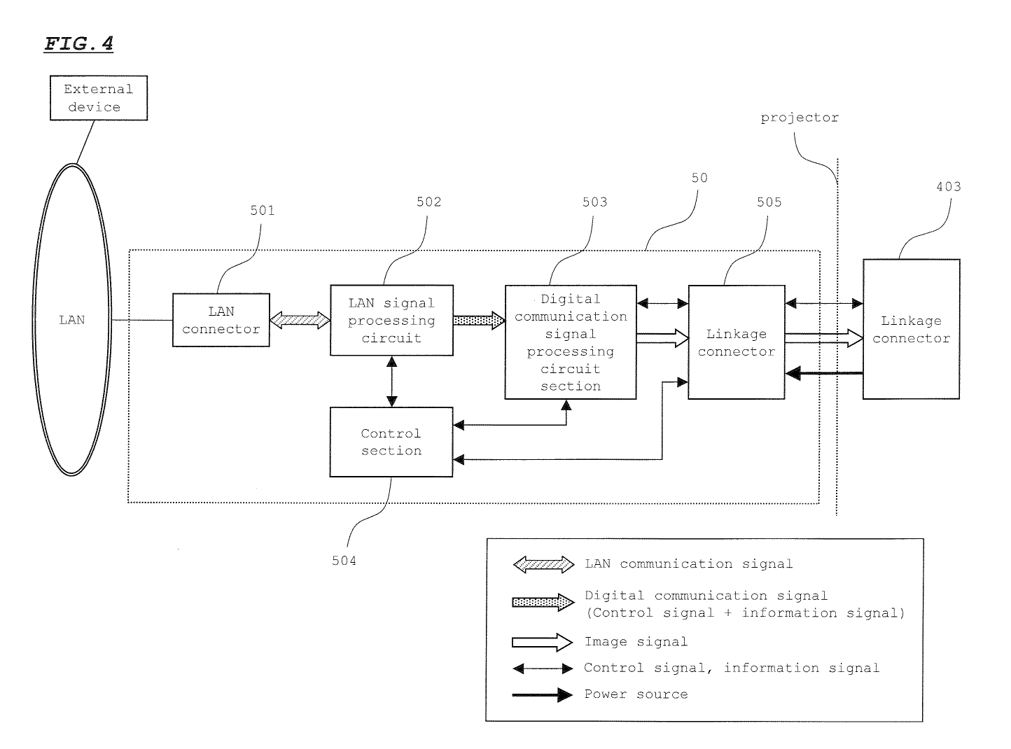

FIG. 4 is a circuit block diagram showing a configuration of the functionality expansion unit 50.

The functionality expansion unit 50 includes a LAN connector 501, a LAN signal processing circuit section 502, a digital communication signal processing circuit section 503, a control section 504, and a linkage connector 505.

If the functionality expansion unit 50 is to be used, the LAN connector 501 is connected with a LAN cable for LAN communications.

A communication signal from the LAN is input into the LAN signal processing circuit section 502 via the LAN connector 501. This communication signal from the LAN contains a control signal from the external device for remote control of the projector. Further, the communication signal also contains an image signal from the external device and a control signal from the external device used for image display. The LAN signal processing circuit section 502 subjects the communication signal from the LAN to a decoding process and the like for conversion into a digital communication signal capable of being processed by the digital communication signal processing circuit section 503. The LAN signal processing circuit section 502 then outputs the converted signal to the digital communication signal processing circuit section 503.

The digital communication signal processing circuit section 503 extracts an image signal from the input digital communication signal. The digital communication signal processing circuit section 503 then converts the extracted image signal into an image signal in a transmission mode suitable for communications with the digital communication signal processing circuit section 404 on the projector side, for example, in a low voltage differential signaling (LVDS) mode, and outputs the same to the linkage connector 505.

In addition, the digital communication signal processing circuit section 503 also extracts a control signal from the input digital communication signal, and outputs the same to the control section 504.

The control section 504 controls the LAN signal processing circuit section 502 and the digital communication signal processing circuit section 503 for proper execution of signal processing. The control section 504 also outputs the control signal from the digital communication signal processing circuit 503 to the linkage connector 505.

The linkage connector 505 is connected to the linkage connector 403 on the projector side via a dedicated cable or the like, and transmits the input image signal and control signal to the linkage connector 403.

Returning to FIG. 3, the image signal from the functionality expansion unit 50 is input into the digital communication signal processing circuit section 404 via the linkage connector 403. The digital communication signal processing circuit section 404 converts the input image signal into digital image signals corresponding to RGB lights, and outputs the same to the image signal processing section 405.

The image signal processing section 405 generates drive signals from the input image signals to drive the liquid crystal panels 203, 204, and 205 for RGB lights, and outputs the same to the panel driving control section 406. The panel driving control section 406 drives the liquid crystal panels 203, 204, and 205, in accordance with the respective drive signals.

A control signal from the functionality expansion unit 50 is input into the control section 407 via the linkage connector 403.

When a control signal for remote control is input from the LAN signal processing circuit section 402 or the functionality expansion unit 50, the control section 407 executes various kinds of control in accordance with the control signal. For example, if the control signal is a signal for an instruction to start operation, the control section 407 starts operation of the projector in a standby status, and if the control signal is a signal for an instruction to stop operation, the control section 407 stops the projector in an operational status.

In addition, when a control signal for use in image display is input from the functionality expansion unit 50, the control section 407 executes a process for synchronizing the digital communication signal processing circuit section 404, the image signal processing section 405, and the panel driving control section 406 or the like, in accordance with the control signal.

Further, when a control signal for an instruction to acquire information on projector status, for example, an operational status of the projector (whether in operation or on standby), information on light source output (whether the light source turns on in a normal mode or a power-saving mode), and information on light source temperature or the like is input, the control section 407 acquires these kinds of information.

If the LAN signal processing circuit section 402 is in operation, the control section 407 outputs an information signal indicating the acquired projector status to the LAN signal processing circuit section 402. The LAN signal processing circuit section 402 subjects the input information signal to a coding process and the like for conversion into a communication signal capable of being transmitted over the LAN, and outputs the same to the LAN via the LAN connector 401.

Meanwhile, if the functionality expansion unit 50 is in operation, the control section 407 outputs the foregoing information signal to the digital communication signal processing circuit section 404.

The digital communication signal processing circuit section 404 converts the input information signal into an information signal in a transmission mode suitable for communications with the digital communication signal processing circuit section 503 on the functionality expansion unit 50 side, for example, an information signal in a serial mode, and sends the same to the digital communication signal processing circuit section 503 via the two linkage connectors 403 and 505.

The digital communication signal processing circuit section 503 converts the input information signal into an information signal capable of being processed by the LAN signal processing circuit section 502, and sends the same to the LAN signal processing circuit section 502 via the control section 504. The LAN signal processing circuit section 502 subjects the input information signal to a coding process and the like for conversion into a communication signal capable of being transmitted over the LAN, and outputs the same to the LAN via the LAN connector 501.

Accordingly, the information signal indicating a projector status is transmitted to the external device over the LAN.

The power source section 408 supplies power to the LAN signal processing circuit section 402. The power source section 408 also supplies power to the functionality expansion unit 50 via the linkage connector 403. Further, the power source section 408 supplies power to each components such as the control section 407 and the light source 201. For convenience' sake, FIG. 3 shows only a power line to the LAN signal processing circuit section 402 and the functionality expansion unit 50 by arrows.

When the functionality expansion unit 50 is connected to the linkage connector 403, the functionality expansion unit 50 outputs a connection signal indicating this connection state to the control section 407 via the linkage connector 403. Depending on the presence or absence of a connection signal, the control section 407 determines whether the functionality expansion unit 50 is connected.

The input section 409 outputs a control signal in accordance with a key operation on the operation section 104 or a control signal in accordance with a key operation on a remote control (not shown) to the control section 407. A user can perform a key operation with the operation section 104 or the remote control to select whether to provide the projector with a communication function (hereinafter, referred to as “presence or absence of a communication function”). When any setting is made on the presence or absence of a communication function, the control section 407 stores the setting in the memory 410.

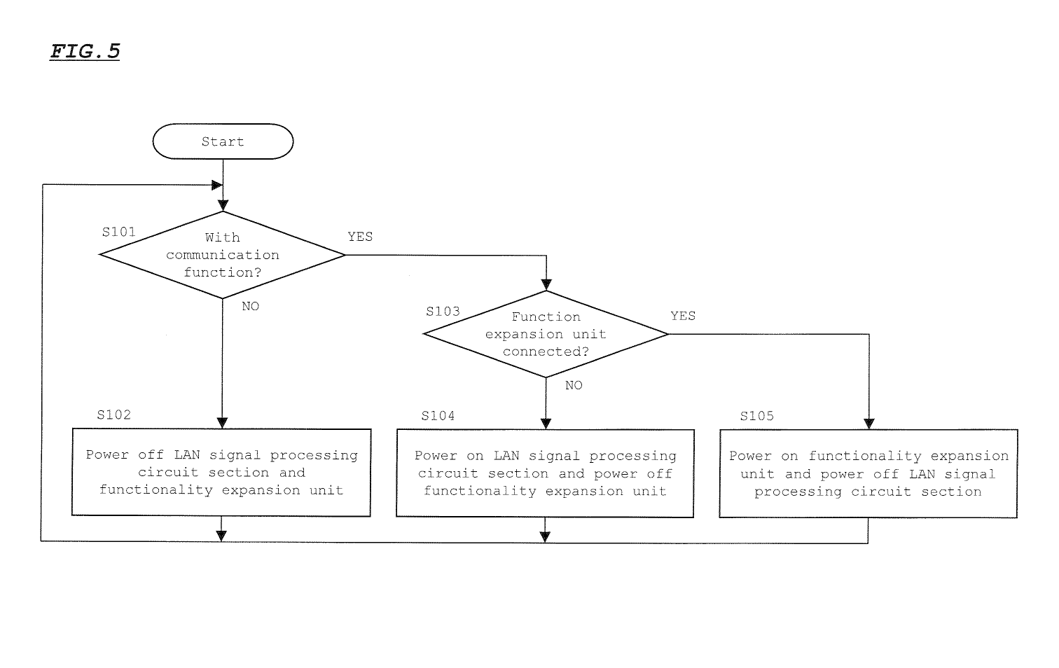

The control section 407 controls the power source section 408, depending on the setting of presence or absence of a communication function and the presence or absence of connection of the functionality expansion unit 50. The control of the power source section 408 will be described later with reference to FIG. 5.

The control section 407 is connected to the memory 410. The memory 410 stores a control program for providing the control section 407 with a control function. The control section 407 has a CPU to control components in accordance with the control program. In addition, the memory 410 stores various kinds of information on setting made by the user through the input section 409.

FIG. 5 is a flowchart of a power supply control process on the LAN signal processing circuit section 402 and the functionality expansion unit 50.

The control section 407 first makes a determination on the presence or absence of a communication function (S101). When communication is performed with an external device over the LAN, a user makes a setting of “With a communication function” through a key operation. Meanwhile, if not performing communications with an external device, the user makes a setting of “Without a communication function” through a key operation.

If the setting is “Without a communication function” (S101: NO), the control section 407 controls the power source section 408 so as not to supply power to both the LAN signal processing circuit section 402 and the functionality expansion unit 50 (S102).

Meanwhile, if the setting is “With a communication function” (S101: YES), the control section 407 then determines whether the functionality expansion unit 50 is connected (S103).

If the projector is connected to the external device over the LAN only for the purpose of remote control or status monitoring of the projector, the functionality expansion unit 50 is generally not connected because communications can be performed only with the LAN signal processing circuit section 402 built into the projector.

If determining at step S103 that the functionality expansion unit 50 is not connected (S103: NO), the control section 407 controls the power source section 408 so as to supply power to the LAN signal processing circuit section 402. At the same time, the control section 407 controls the power source section 408 so as not to supply power to the functionality expansion unit 50 via the linkage connector 403 (S104).

Accordingly, the LAN signal processing circuit section 402 is activated so that a control signal for remote control and an information signal indicating a projector status are transmitted and received through the LAN signal processing circuit section 402, as described above.

Meanwhile, if the projector is connected to the external device over the LAN for the purpose of allowing the projector to project an image from the external device, in addition to remote control or status monitoring of the projector, the user connects the functionality expansion unit 50, because an image signal cannot be communicated only with the LAN signal processing circuit section 402 built into the projector.

If determining at step S103 that the functionality expansion unit 50 is connected (S103: YES), the control section 407 controls the power source section 408 so as to supply power to the functionality expansion unit 50 via the linkage connector 403 and so as not to supply power to the LAN signal processing circuit section 402 (S105).

Accordingly, the functionality expansion unit 50 is activated so that an image signal, a control signal for remote control, and an information signal indicating a projector status are transmitted and received through the functionality expansion unit 50, as described above.

These steps S101 to S105 are repeatedly carried out while the projector is powered and the control section 407 is in operation.

In this embodiment, as described above, the user can make a selection on whether to use the LAN signal processing circuit section 402 built into the projector or use the functionality expansion unit 50, depending on the kind of a signal received over the LAN.

Therefore, if communications can be performed only with the LAN signal processing circuit section 402, there is no need to use the functionality expansion unit 50. This saves the user from having to connect the functionality expansion unit 50 or purchase the functionality expansion unit 50 at a store or the like. In addition, the LAN signal processing circuit section 402 requires a smaller amount of power consumption than that required for the functionality expansion unit 50, thereby reducing power consumption of the projector.

Further, the projector mainly includes the LAN signal processing circuit section 402, which achieves reduction in cost for the projector as compared to the case where the function of the functionality expansion unit 50 is implemented within the projector.

According to this embodiment, as described above, it is possible to provide a projector that allows adaptive selection of a network communication mode while suppressing cost increase.

### Modification Example 1

In the foregoing embodiment, whether to use the LAN signal processing circuit section 402 or the functionality expansion unit 50 is selected depending on the presence or absence of connection of the functionality expansion unit 50 to the projector. In this modification example, alternatively, the user selects whether to use the LAN signal processing circuit section 402 or the functionality expansion unit 50, through an input operation with the operation section 104 or the remote control.

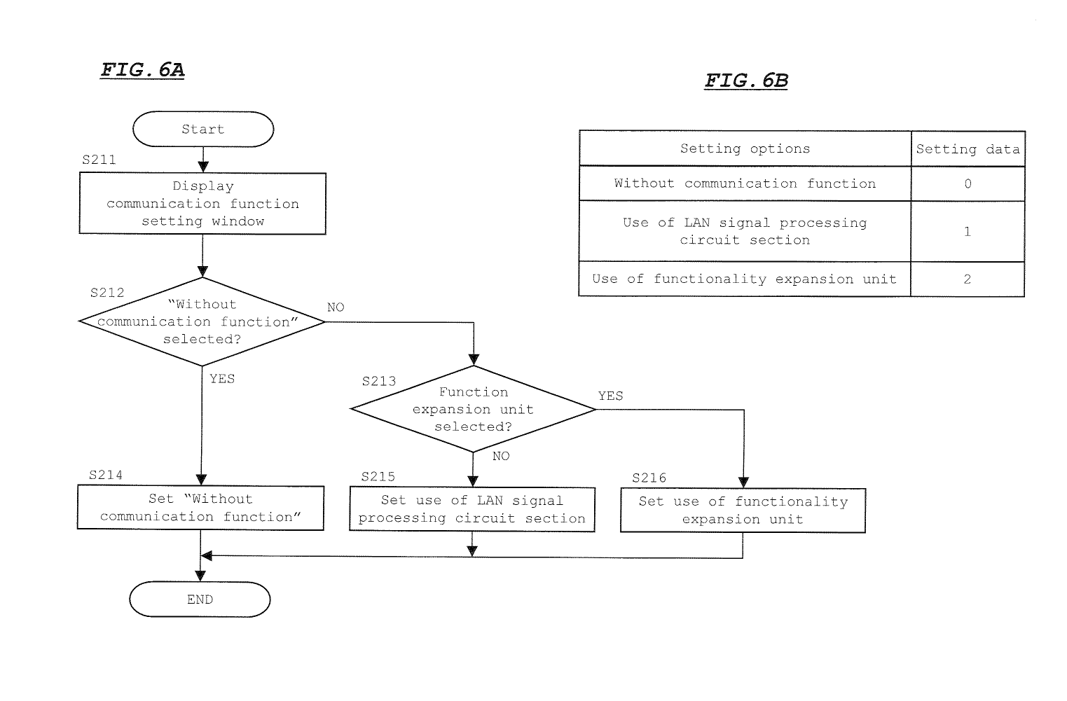

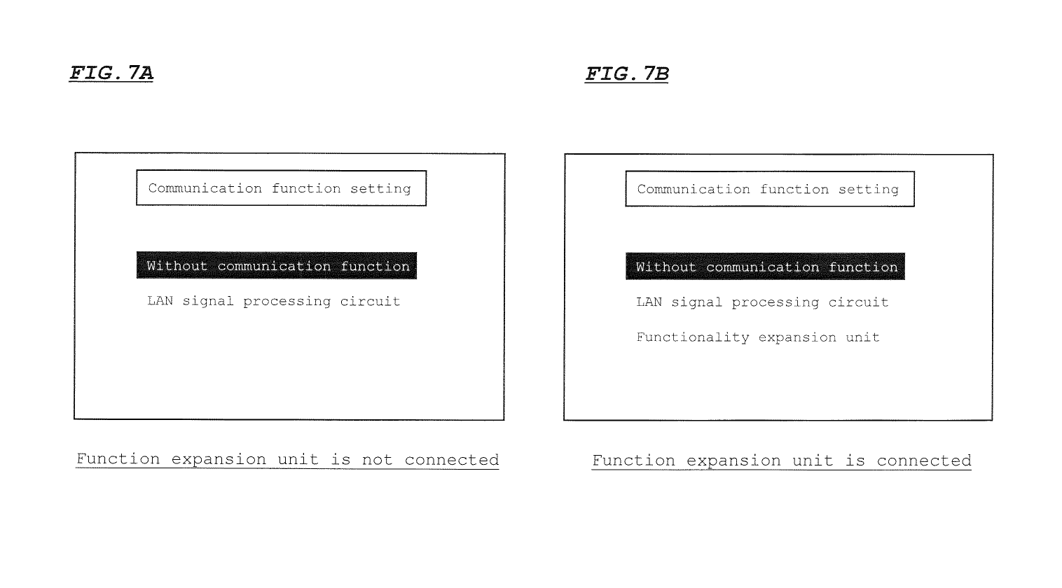

FIG. 6A is a flowchart of a communication function setting process in modification example 1. FIG. 6B is a diagram showing setting data corresponding to setting options in modification example 1. FIGS. 7A and 7B show display examples of a communication function setting window in modification example 1.

When the user performs a key operation for displaying a communication function setting window, the control section 407 displays the communication function setting window on a screen (S211). At that time, if the functionality expansion unit 50 is not connected, the window offers two options “Without communication function” and “LAN signal processing circuit section” as shown in FIG. 7A. Meanwhile, if the functionality expansion unit 50 is connected, the window offers three options “Without communication function”, “LAN signal processing circuit section”, and “Function expansion unit”, as shown in FIG. 7B. The user selects a desired one of the options in the communication function setting window. For example, the user highlights a desired option and confirms the selection, as shown in the screens of FIGS. 7A and 7B.

If the option “Without a communication function” is selected (S212: YES), the control section 407 makes a setting of not using a communication function (S214). In this case, setting data “0” is stored in a predetermined storage area of the memory 410, as shown in FIG. 6B. If the option “LAN signal processing circuit section” is selected (S213: NO), the control section 407 makes a setting of using the LAN signal processing circuit section 402 (S215). In this case, setting data “1” is stored in the predetermined storage area of the memory 410, as shown in FIG. 6B. If the option “Functional expansion unit” is selected (S213: YES), the control section 407 makes a setting of using the functionality expansion unit 50 (S216). In this case, setting data “2” is stored in the predetermined storage area of the memory 410, as shown in FIG. 6B.

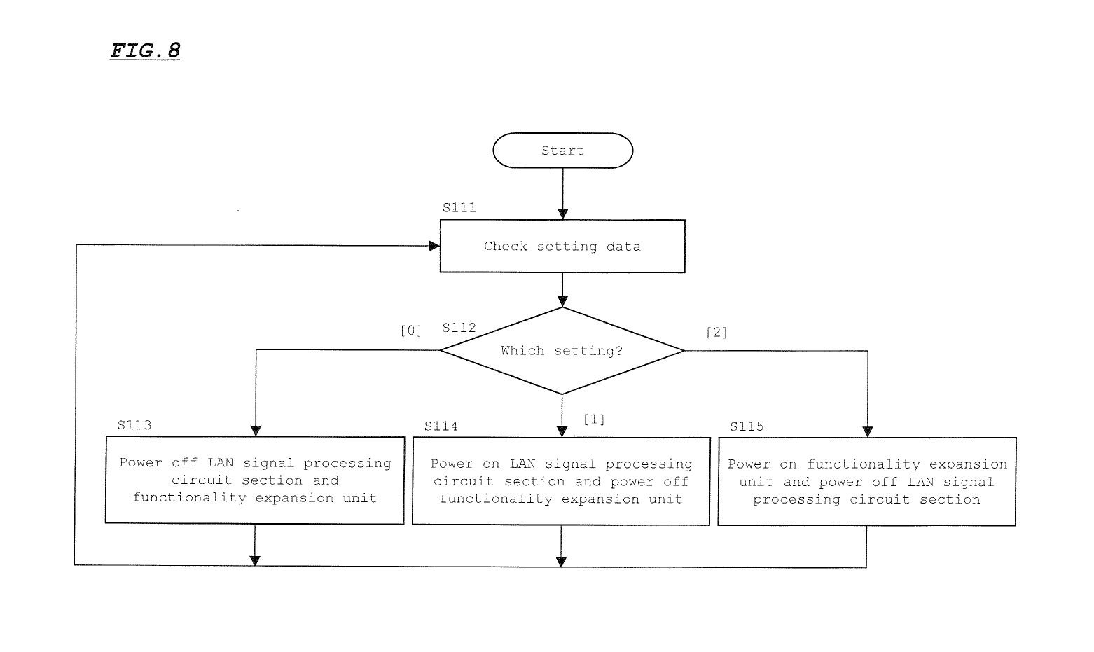

FIG. 8 is a flowchart of a power supply control process on the LAN signal processing circuit section 402 and the functionality expansion unit 50 in modification example 1.

The control section 407 first checks the setting data stored in the memory 410 (S111). Then, the control section 407 determines which of the setting data is stored (S112). In the case of the setting data “0”, that is, the setting of not using a communication function, the control section 407 controls the power source section 408 so as not to supply power to both the LAN signal processing circuit 402 and the functionality expansion unit 50 (S113). In the case of the setting data “1”, that is, the setting of using the LAN signal processing circuit section 402, the control section 407 controls the power source section 408 so as to supply power to the LAN signal processing section 402 and so as not to supply power to the functionality expansion unit 50 (S114). In the case of the setting data “2”, that is, the setting of using the functionality expansion unit 50, the control section 407 controls the power source section 408 so as to supply power to the functionality expansion unit 50 and so as not to supply power to the LAN signal processing circuit 402 (S115).

While the control section 407 is in operation, the foregoing steps S111 to S115 are repeated.

In this manner, the configuration of modification example 1 can produce the same advantage as that of the foregoing embodiment. In addition, modification example 1 allows a user to select arbitrarily the communication processing section to be used, which results in increased convenience of a user.

### Modification Example 2

When the projector is powered, the control section 407 and other necessary circuit sections are activated to bring the projector into a standby status. After that, when the user presses a power switch on the operation section 104 or the remote control to start operation, the lamp and the liquid crystal panels are driven to start projection of an image.

In modification example 1 described above, it is not possible to set a communication function separately for a standby status and an operational status.

In some cases, however, different kinds of signals may be communicated between when the projector is on standby and when the projector is in operation. For example, in the configuration where an image signal is to be transmitted to the projector over the LAN, the image signal, a control signal for remote control, and an information signal indicating a projector status may be communicated while the projector is in operation, whereas no image signal is communicated while the projector is on standby.

Accordingly, modification example 2 is configured to allow separate settings of a communication function for a standby status and an operational status of the projector.

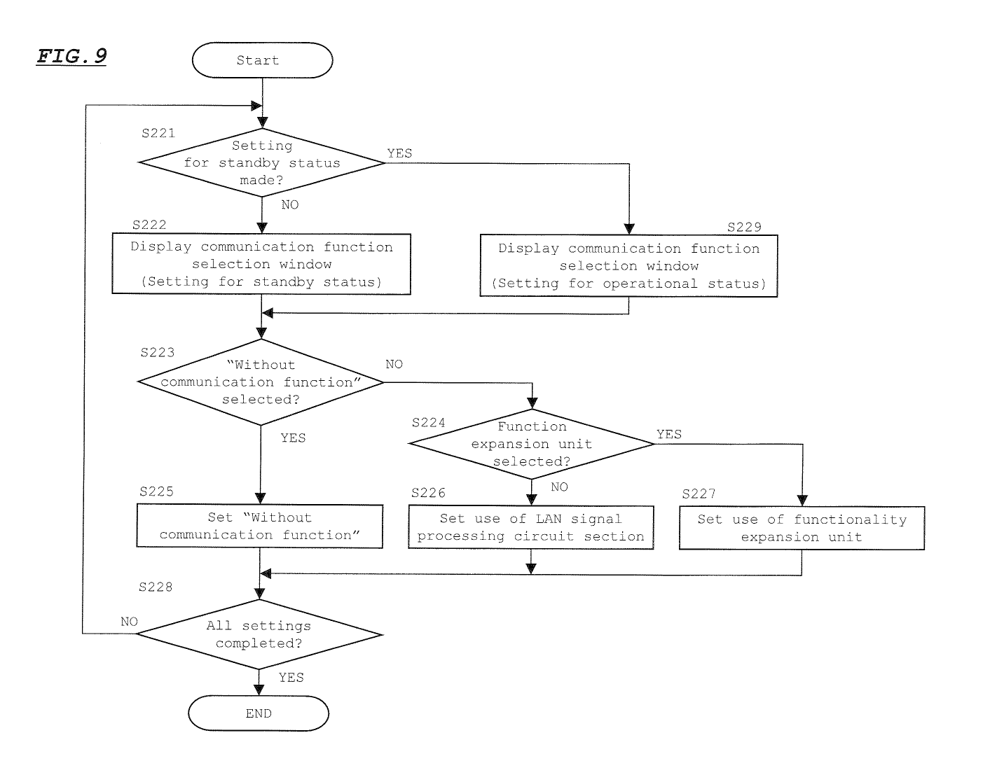

FIG. 9 is a flowchart of a communication function setting process in modification example 2.

When the user performs a key operation for displaying a communication function setting window, the control section 407 determines whether a setting for a standby status is made (S221). If the setting for a standby status is not made (S221: NO), the control section 407 first displays a communication function setting window for making a setting for a standby state on the screen (S222). At that time, the communication function setting window is the same as that shown in FIGS. 7A and 7B, and may include an additional indication of the setting for a standby status as appropriate. The user selects a desired option for the setting for a standby status.

If the option “Without a communication function” is selected in this window (S223: YES), the control section 407 makes a setting of not using a communication function (S225). If the option “LAN signal processing circuit section” is selected (S224: NO), the control section 407 makes a setting of using the LAN signal processing circuit section 402 (S226). If the option “Functionality expansion unit” is selected (S224: YES), the control section 407 makes a setting of using the functionality expansion unit 50 (S227).

The setting data corresponding to the setting options are the same as those in modification example 1, as shown in FIG. 6B. If the user selects any option, the setting data corresponding to the option (“0”, “1”, or “2”) is stored in a storage area for a standby status of the memory 410.

Accordingly, upon completion of the setting for a standby status (S228: NO→S221: YES), the control section 407 then displays a communication function setting window for making a setting for an operational status (S229). This communication function setting window is also the same as those shown in FIGS. 7A and 7B, and may include an additional indication of the setting for an operational status as appropriate.

When the setting is made in the same manner as that for a standby status (S223 to S227), the setting data corresponding to the selected option (“0”, “1”, or “2”) is stored in a storage area for an operational status of the memory 410. Accordingly, the settings of the communication processing sections for a standby status and an operational status are completed.

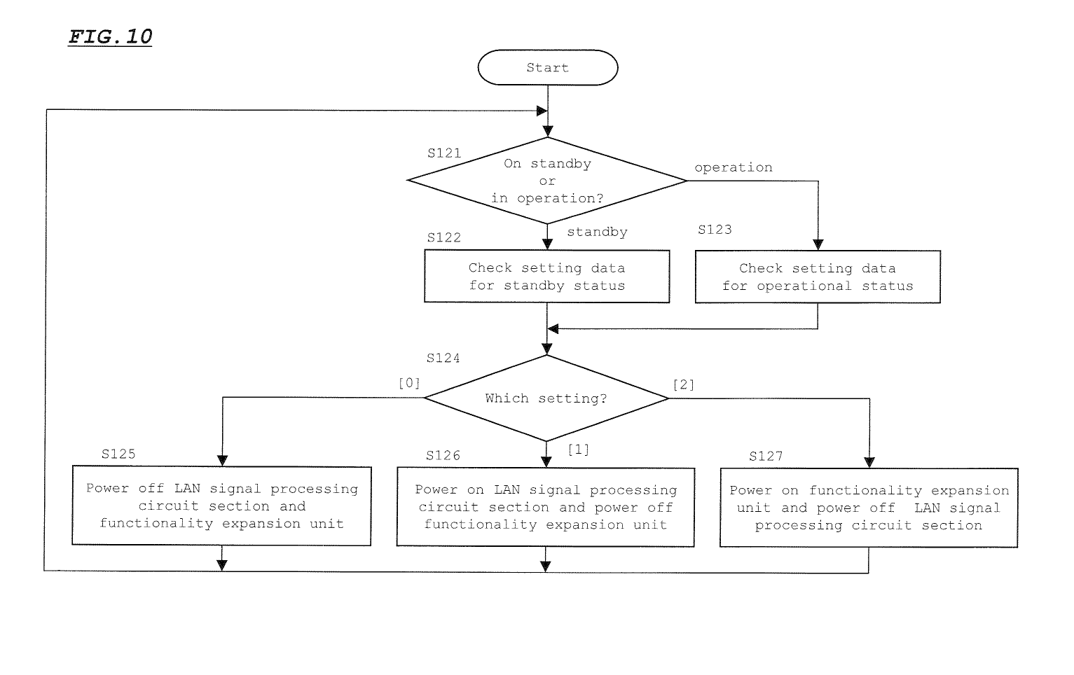

FIG. 10 is a flowchart of a power supply control processing on the LAN signal processing circuit section 402 and the functionality expansion unit 50 in modification example 2.

The control section 407 first determines whether the projector is in a standby status or in an operational status (S121). Then, if the projector is in a standby status (S121: standby status), the control section 407 checks the setting data for a standby status (S122), and controls the power source section 408 based on the setting data in the same manner as the case of modification example 1 (S124 to S127).

Meanwhile, if the projector is in an operational status (S121: Operational status), the control section 407 checks the setting data for an operational status (S123), and controls the power source section 408 based on the setting data (S124 to S127).

In this manner, the configuration of modification example 2 allows the user to make a more detailed selection on whether to use the LAN signal processing circuit section 402 built into the projector or use the functionality expansion unit 50, depending on the kind of a signal received over the LAN.

For example, even if the functionality expansion unit 50 is connected to support reception of an image signal as described above, there is a low possibility that the projector receives an image signal while the projector is on standby. In addition, the LAN signal processing circuit section 402 requires a smaller amount of power consumption than that required by the functionality expansion unit 50.

Therefore, in this case, the user can make a setting such that the LAN signal processing circuit section 402 is used while the projector is on standby, and the functionality expansion unit 50 is used while the projector is in operation. If such a setting is made, the LAN signal processing circuit section 402 is powered and activated while the projector is on standby. In contrast, the functionality expansion unit 50 is powered and activated while the projector is in operation.

In this manner, it is possible to reduce power consumption of the projector as compared to the case where the functionality expansion unit 50 is constantly powered.

### Modification Example 3

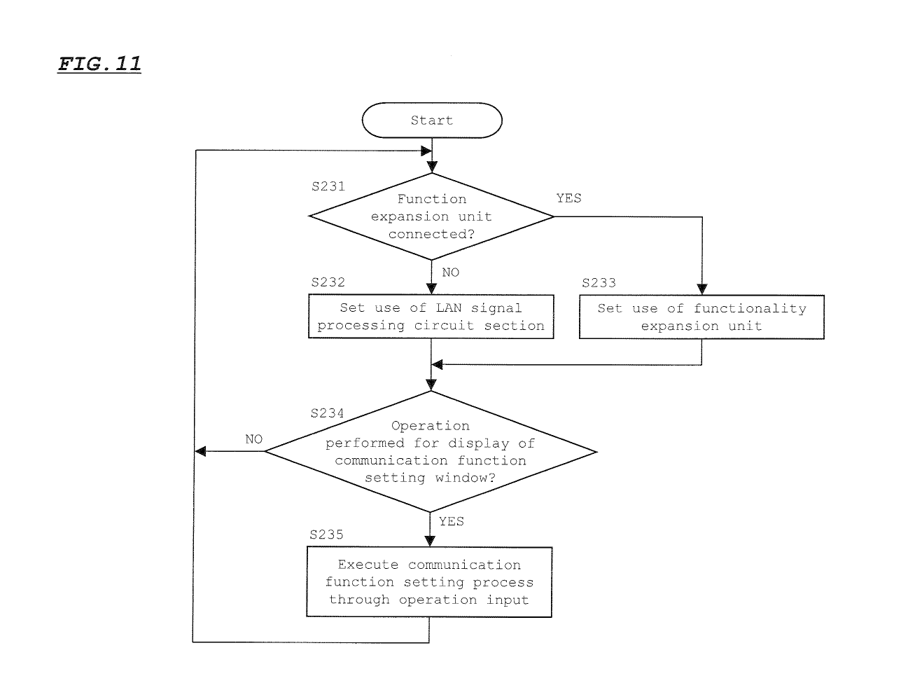

FIG. 11 is a flowchart of a communication function setting process in modification example 3.

In modification examples 1 and 2 described above, the setting of a communication function is made only through an input operation. In this modification example, firstly, a setting is made depending on the presence or absence of connection of the functionality expansion unit 50. After that, the setting can be changed through an input operation.

Specifically, the control section 407 first determines whether the functionality expansion unit 50 is connected (S231). If the functionality expansion unit 50 is not connected (S231: NO), the control section 407 makes a setting of using the LAN signal processing circuit section 402(S232). In contrast, if the functionality expansion unit 50 is connected (S231: YES), the control section 407 makes a setting of using the functionality expansion unit 50(S233).

If wishing to make a change to the previous setting, a user performs a key operation for displaying a communication function setting window (S234: YES).

Accordingly, if determining that the foregoing key operation is performed, the control section 407 executes a communication function setting process (S211 to S216) through an input operation, as shown in FIGS. 6A and 6B (S235).

In this manner, in the configuration of modification 3, an automatic setting is first made on the basis of the presence or absence of connection of the functionality expansion unit 50, and therefore the user only needs to perform an input operation in the case of making a change to the setting. This allows the user to make a setting by easy operation.

At step S235, the setting process shown in FIG. 9 may be performed in place of the setting process shown in FIGS. 6A and 6B. In this case, the control section 407 makes a setting of using the LAN signal processing circuit section 402 (“1”) in both of a standby status and an operational status at step S232, and the control section 407 makes a setting of using the functionality expansion unit 50 (“2”) in both of a standby status and an operational status at step S233.

### Modification Example 4

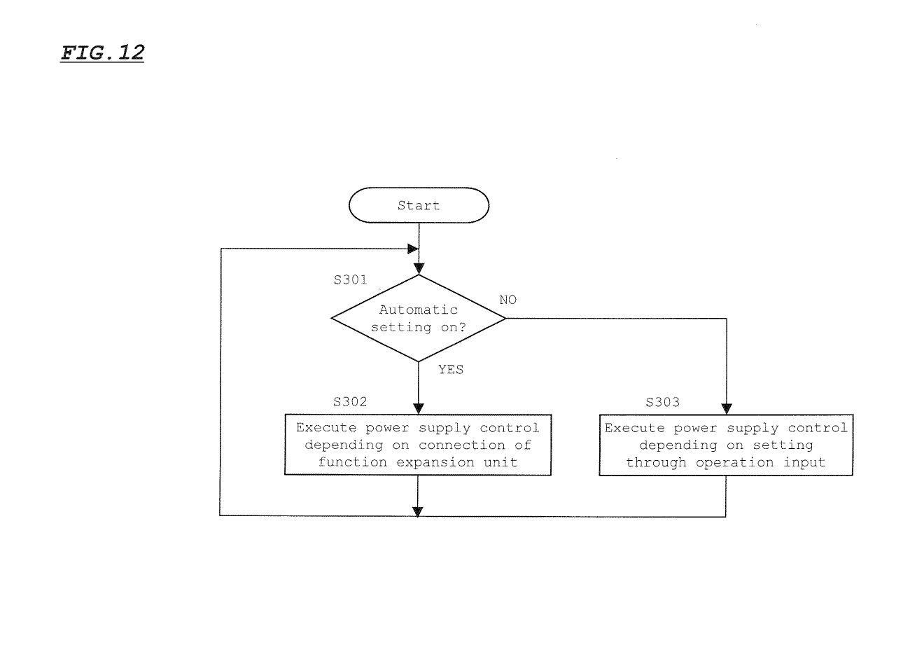

FIG. 12 is a flowchart of a power supply control process on the LAN signal processing circuit section 402 and the functionality expansion unit 50 in modification example 4.

In this modification example, the user can select which of modes to be enabled, that is, a mode in which the LAN signal processing circuit section 402 or the functionality expansion unit 50 is automatically selected depending on the presence or absence of connection of the functionality expansion unit 50, as in the foregoing embodiment, and a mode in which the LAN signal processing circuit section 402 or the functionality expansion unit 50 is selected according to the setting made by a user's an input operation, as in modification examples 1 and 2.

In the configuration of modification example 4, a user selects in advance whether an automatic setting of a communication function is to be on or off.

If the automatic setting is on (S301: YES), the control section 407 executes the power supply control shown in FIG. 5 as in the foregoing embodiment (S302). Meanwhile, if the automatic setting is off (S301: NO), the control section 407 executes the power supply control shown in FIG. 8 as in modification example 1 (S303). Otherwise, if the automatic setting is off (S301: NO), the control section 407 executes the power supply control shown in FIG. 11 as in modification example (S303).

In this manner, the configuration of modification 4 allows the user to be select one of the two modes described above for selecting the LAN signal processing circuit section 402 or the functionality expansion unit 50.

### Others

The embodiment of the present invention can further be modified in various manners besides the foregoing ones.

For example, in the foregoing embodiment, the external device and the projector are connected over a wired LAN. However, the present invention is not limited by this configuration, and the external device and the projector may be connected over a wireless LAN or any other network.

In addition, a combination of the first communication processing section and the second communication processing section in the present invention is not limited by the example of the foregoing embodiment. For example, any signal processing circuit section supporting wired LANs may be disposed as first communication processing section in the projector, and any signal processing circuit section supporting wireless LANs may be disposed as second communication processing section in the functionality expansion unit 50. Since wireless LANs require the function of transmitting signals in a wireless manner, the signal processing circuit section supporting wireless LANs has more advanced capability than that of the LAN signal processing circuit section.

Alternatively, as second communication processing section, any signal processing circuit section supporting optical communications may be disposed in the functionality expansion unit 50. Since optical communications require the function of converting an electrical signal into an optical signal, the signal processing circuit section supporting optical communications has more advanced capability than that of the LAN signal processing circuit section.

Besides, the embodiment of the present invention can be appropriately modified in various manners, within the scope of technical ideas recited in the claims.

What is claimed is:

1. A projection display device that modulates light from a light source and projects the same onto a projection plane, comprising:
a first communication processing section for performing communications over a network;
an interface that is connected to a communication device having a second communication processing section with more advanced processing capability than that of the first communication processing section; and
a selecting section that selects the first communication processing section or the second communication processing section disposed in the communication device, for use in communications with the network.

2. The projection display device according to claim 1, wherein
the selecting section selects the first communication processing section if the communication device is not connected, and selects the second communication processing section if the communication device is connected.

3. The projection display device according to claim 1, further comprising
an accepting section that accepts input of an instruction on whether to use the first communication processing section or the second communication processing section, for communications with the network, wherein
the selecting section
selects the first communication processing section if an instruction for selecting the first communication processing section is input, and
selects the second communication processing section if an instruction for selecting the second communication processing section is input.

4. The projection display device according to claim 1, further comprising
a setting section that sets whether to be used the first communication processing section or the second communication processing section when the projection display device is in a standby status and an operational status, wherein
the selecting section selects the first communication processing section or the second communication processing section, which is set by the setting section, when the projection display device is in the standby status and the operational status.

5. The projection display device according to claim 1, further comprising
a power supply section that supplies power to the first communication processing section and the second communication processing section, wherein
the power supply section shuts down power supply to the first communication processing section or the second communication processing section, which is not selected by the selecting section.

6. The projection display device according to claim 1, wherein
the second communication processing section has a function of extracting a signal corresponding to an image signal from a communication signal received over the network.
